(19) United States
(12) Patent Application Publication
(10) Pub. No.: US 2011/0073746 A1
(43) Pub. Date: Mar. 31, 2011

(54) Air Conditioning Bracket/Brace

(76) Inventor: Triandafilos Padiotis, Chantilly, VA (US)

(21) Appl. No.: 12/423,121

(22) Filed: Apr. 14, 2009

(51) Int. Cl. F16M 13/02

(52) U.S. Cl. 248/674

(57) ABSTRACT

An air-conditioner bracket for supporting an air-conditioner unit may include an opposing pair of side members having a substantially horizontal side surfaces to support the air-conditioning unit, a front member having a substantially horizontal front surface to support the air-conditioning unit, a back member having a substantially horizontal back surface to support the air-conditioning unit. The front member may include a flange member, and each of the opposing side members may be triangular shaped. The opposing side members may be a truncated triangular shape, and the back support member includes a back flange member. The side member may include an upper side shoulder member, and the side member may include a retaining wall.

### FIELD OF THE INVENTION

The present invention relates to the installation of an air conditioners generally and, more particularly, but not by way of mounting a condenser unit, heat pump unit or other type of outdoor unit away from the ground level.

### BACKGROUND OF THE INVENTION

Central air conditioners are widely used for cooling selected portions of buildings or the entire building. Typically, the condenser unit, heat pump unit or in general the outdoor unit sits on a pad which is placed on the ground. In this position, the air conditioning unit is subject to being obstructed by snow, mud, long grass, weeds, flooding and an area having a steep grade. Furthermore, a ground-based air conditioning unit generally interferes with the operation of a sprinkler system, requiring additional sprinkler heads in order to provide coverage around the ground-based air conditioning unit.

U.S. Pat. No. 5,636,816 discloses a mounting bracket for support of a window air conditioner on a window sill installed in a window opening in a wall of a building. The bracket includes a generally horizontal support member for supporting a portion of the window air conditioner extending outside of the building, a proximal end of the generally horizontal support member being for attachment to the window sill; a foot member to rest against an outside surface of the wall below the window opening; a strut member having an upper end thereof attached to an attachment point near a distal end of the generally horizontal support member and a lower end thereof attached to the foot member; and apparatus to selectively adjust height of the proximal end of the generally horizontal support member above the window sill, depending on construction of the window sill and obstacles in the window.

This bracket is not suitable for mounting a condenser unit, heat pump unit or other outdoor unit because these types of units typically cannot fit through a window.

### SUMMARY

An air-conditioner bracket for supporting an air-conditioner unit may include an opposing pair of side members having a substantially horizontal side surfaces to support the air-conditioning unit, a front member having a substantially horizontal front surface, a back member having a substantially horizontal back surface to support the air-conditioning unit.

The front member may include a flange member, and each of the opposing side members may be triangular shaped.

The opposing side members may be a truncated triangular shape, and the back support member includes a back flange member.

The side member may include an upper side shoulder member, and the side member may include a retaining wall.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the air conditioning bracket of the present invention;

FIG. 2 illustrates an exploded view of the air conditioning bracket of the present invention;

FIG. 3 illustrates a top view of the air conditioning bracket of the present invention;

FIG. 4 illustrates a front view of the air conditioning bracket of the present invention;

FIG. 5 illustrates a side view of the air conditioning bracket of the present invention;

FIG. 6 illustrates a back view of the air conditioning bracket of the present invention;

FIG. 7 illustrates a perspective view of the air conditioning bracket and air conditioning unit.

### DETAILED DESCRIPTION

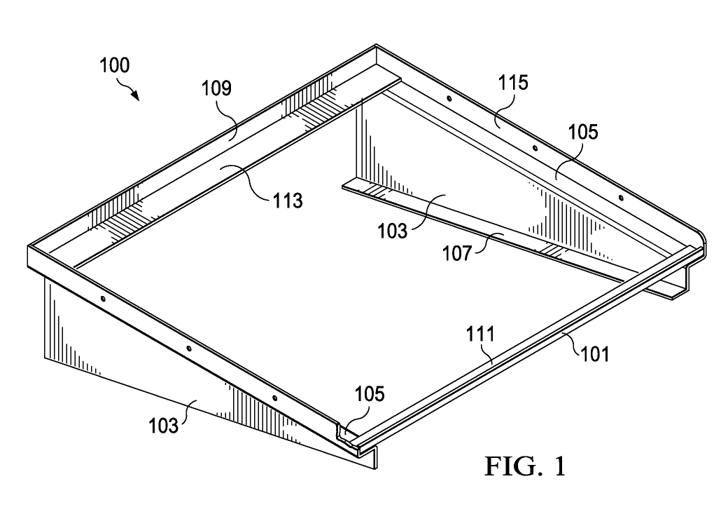

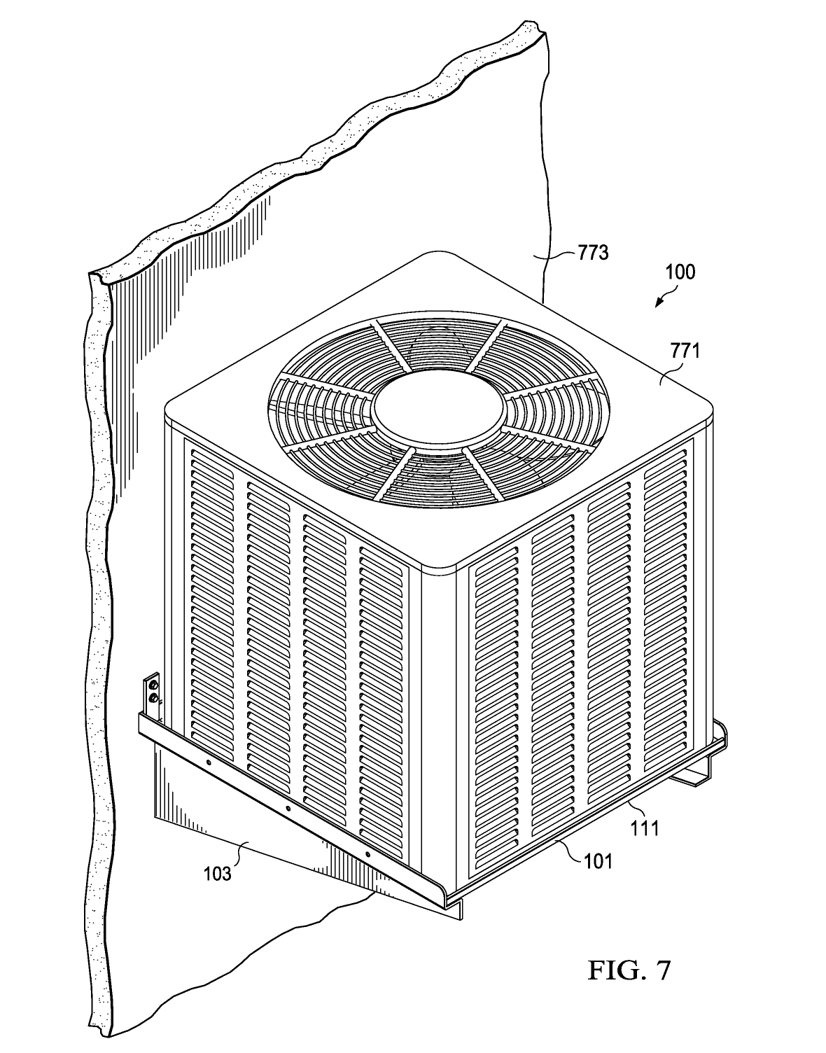

FIG. 1 illustrates a perspective view of the air-conditioner bracket 100 of the present invention which may be formed from frame members which may be substantially thin, substantially rigid and substantially flat members which may be made from metals such as steel or other appropriate material. The air-conditioner bracket 100 may include side members 103 which may be substantially triangular shaped which may be truncated and may include an edge which may be integral with a lower side support member 107 which may be substantially perpendicular to the side member 103 and may be substantially horizontal. The side member 103 may include another edge which may be integral with the upper side shoulder member 105 which may be substantially perpendicular to the side member 103 and the upper side shoulder member 105 may include an edge which may be integral with a retaining wall 115 which may be substantially perpendicular to the upper side shoulder member 105. The shoulder member 105 may support the conditioner (as shown in FIG. 7). The side member 103 may extend beyond the front and back of the air-conditioner (not shown). FIG. 1 additionally illustrates a front support member 111 which may connected to and extend between opposing side members 103 and may include a substantially horizontal surface 111 and may be dimensioned so that the air-conditioner (not shown) may be positioned between the opposing side members 103. An edge of the front support member 111 may be integral to a front flange member 101 which may be substantially perpendicular to the front support member 111. The front flange member 101 may extend between the opposing side members 103. FIG. 1 additionally illustrates a back support member 113 which may include a substantial horizontal surface and may include an edge which may be integral to a back flange member 109. The back member 113 and the back flange member 109 may be connected and extend between the opposing side members 103.

While the present invention speaks of integral connections, a joined connection is within the scope of the present invention. The joint connection may be by soldering, welding or other appropriate methods. Thus, the side member 103 may be joined to the side shoulder member 105 and may be joined to the lower side support member 107. The retaining wall 115 may be joined to the upper side shoulder member 105. Likewise the front support member 111 may be joined to the front flange member 101. A back support member 113 may be joined to the side shoulder member 105.

The front support member 111 and the back support member 113 may be detachably connected to the side member 103 by fastening devices such as screws and bolts or other appropriate devices or may be formed integrally with the side member 103 or may be connected by welding or other such methods to the side member 103.

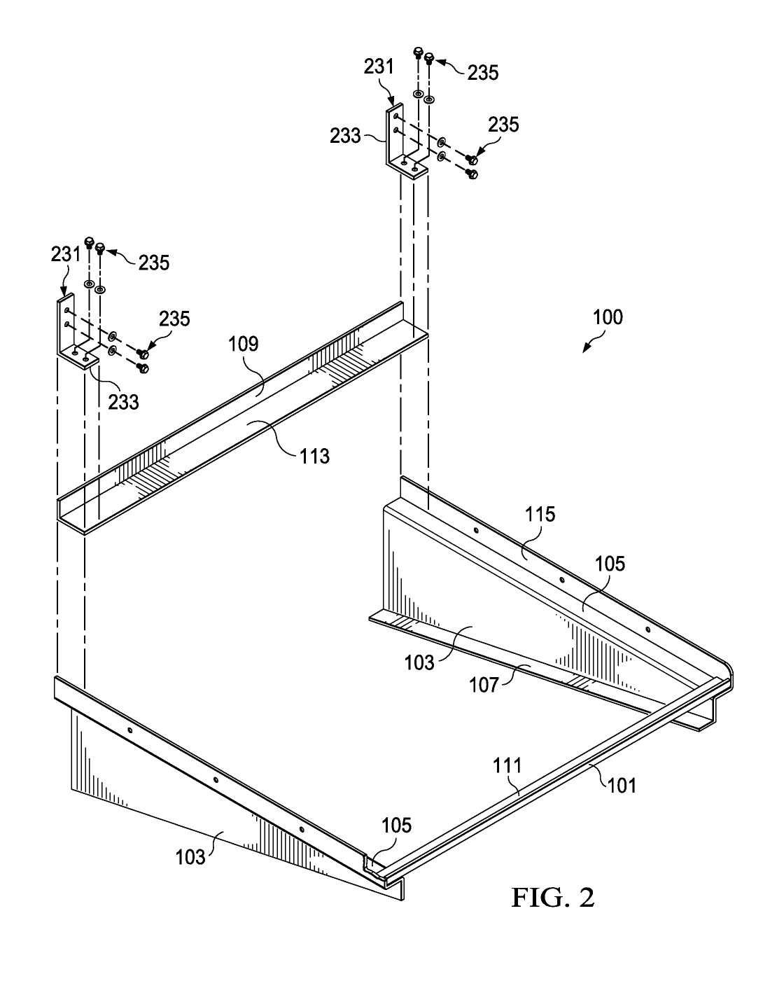

FIG. 2 illustrates an exploded view of the air-conditioner bracket 100 of the present invention which may be formed from frame members which may be substantially thin, substantially rigid, substantially flat members which may be made from metal such as steel or other appropriate material. The air-conditioner bracket 100 may include side members 103 which may be substantially triangular shaped which may be truncated and may include an edge which may be integral with a lower side support member 107 may be substantially perpendicular to the side member 103 and may be substantially horizontal. The side member 103 may include another edge which may be integral with the upper side shoulder member 105 which may be substantially perpendicular to the side member 103 and the upper side shoulder member 105 may include an edge which may be integral with a retaining wall 115 which may be substantially perpendicular to the upper side shoulder member 105. The side member 103 may extend beyond the front and back of the air-conditioner (not shown). FIG. 2 additionally illustrates a front support member 111 which may connected to and extend between opposing side members 103 and may include a substantially horizontal surface 111 and may be dimensioned so that the air-conditioner (not shown) may be positioned between the opposing side members 103. An edge of the front support member 111 may be integral to a front flange member 101 which may be substantially perpendicular to the front support member 111. The front flange member 101 may extend between the opposing side members 103. FIG. 2 additionally illustrates a back support member 113 which may include a substantial horizontal surface and may include an edge which may be integral to a back flange member 109. The back member 113 and the back flange member 109 may be connected and extend between the opposing side members 103.

FIG. 2 additionally illustrates a fastening device 231 for fastening the air conditioning bracket 100 to the side of the building which may be a office building, residents or any other type of building. The fastening device 231 may include a L-shaped bracket 233 and screws/bolts 235 to connect to the building (not shown) and to connect to the side shoulder member 105.

The air-conditioner is lifted on to the air conditioning bracket 100 and may be positioned on the a surface of the side shoulder surface 105 and the back support surface 113 to support the air-conditioner.

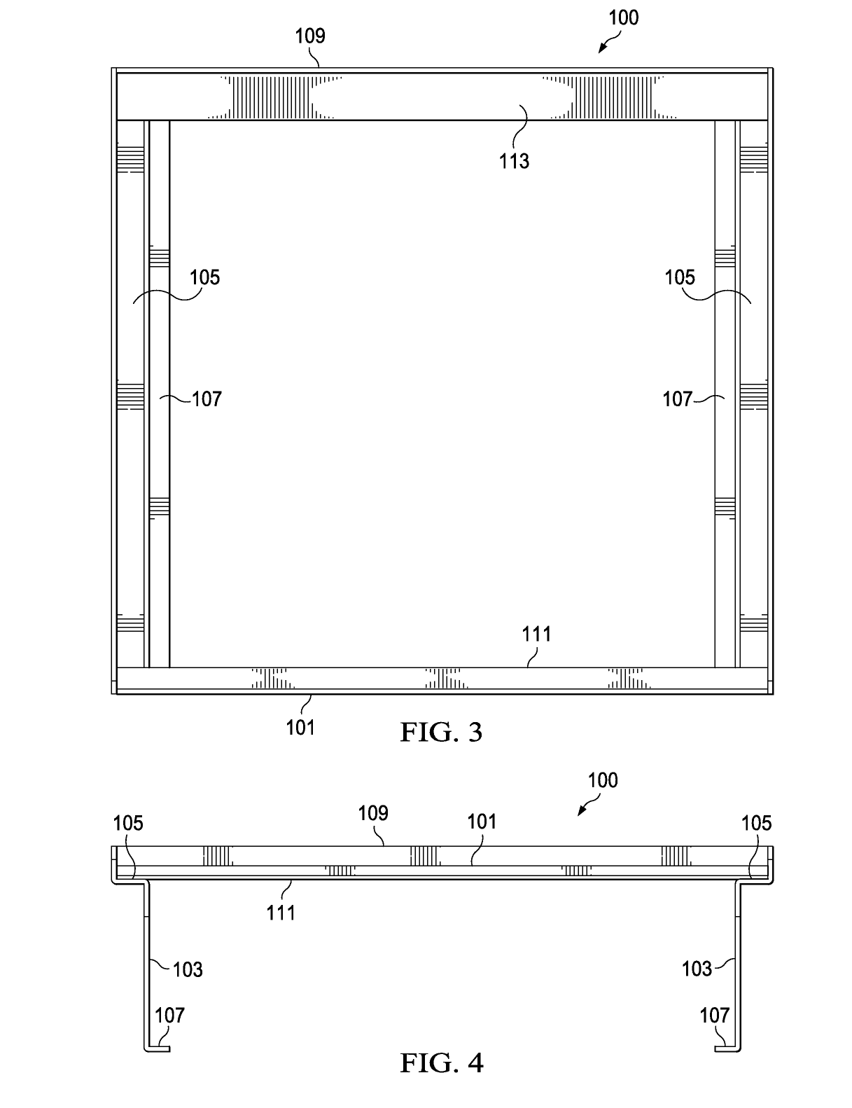

FIG. 3 illustrates a top view of the air-conditioner bracket 100 of the present invention. FIG. 3 illustrates a front support member 111 which extends between the side members 103 and illustrates the back support member 113 which may extend between the side members 103.

FIG. 4 illustrates a front view of the air-conditioner bracelet 100 of the present invention. FIG. 4 additionally illustrates opposing side members 103 and illustrates the front flange member 101.

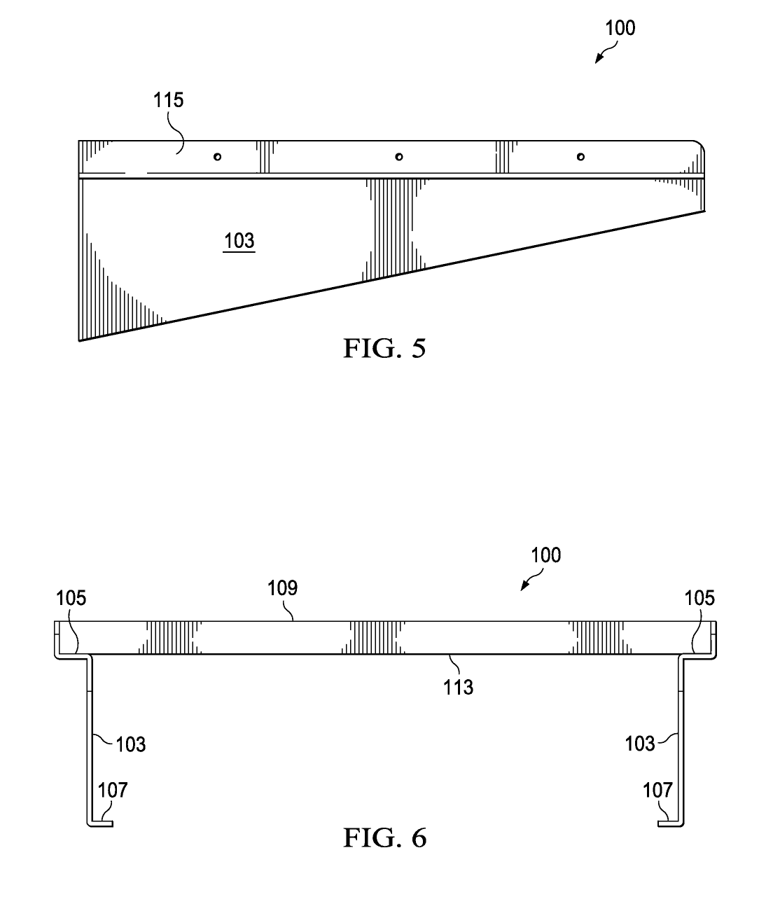

FIG. 5 illustrates a side view of the air-conditioner bracket 100 of the present invention and illustrates the side member 103 and the retaining wall 115.

FIG. 6 illustrates a back view of the air-conditioner bracket 100 of the present invention and illustrates the back flange member 109 and an upper side shoulder member 105.

FIG. 7 illustrates an air conditioning unit 771 which is positioned on the air conditioning bracket 100 and attached to the wall or a substantially vertical surface 773 which may be associated with the building. FIG. 7 illustrates the side member 103 and the front support member 111 which may include a front flange member 101.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An air-conditioner bracket for supporting an air-conditioner unit, comprising:
an opposing pair of side members having a substantially horizontal side surfaces to support the air-conditioning unit;
a front member having a substantially horizontal front surface;
a back member having a substantially horizontal back surface to support the air-conditioning unit.

2) An air-conditioner bracket for supporting an air-conditioner unit as in claim 1, wherein the front member includes a flange member.

3) An air-conditioner bracket for supporting an air-conditioner unit as in claim 1, wherein each of the opposing side members is triangular shaped.

4) An air-conditioner bracket for supporting an air-conditioner unit as in claim 3, wherein the opposing side members are a truncated triangular shape.

5) An air-conditioner bracket for supporting an air-conditioner unit as in claim 1, wherein the back support member includes a back flange member.

6) An air-conditioner bracket for supporting an air-conditioner unit as in claim 1, wherein the side member includes an upper side shoulder member.

7) An air-conditioner bracket for supporting an air-conditioner unit as in claim 1, wherein the side member includes a retaining wall.
